(19) United States
(12) Patent Application Publication
(10) Pub. No.: US 2014/0297969 A1
(43) Pub. Date: Oct. 2, 2014

(54) INFORMATION PROCESSING DEVICE, METHOD FOR CONTROLLING INFORMATION PROCESSING DEVICE, AND PROGRAM FOR CONTROLLING INFORMATION PROCESSING DEVICE

(71) Applicant: FUJITSU LIMITED, Kawasaki-shi (JP)

(72) Inventor: Jun MOROO, Isehara (JP)

(73) Assignee: FUJITSU LIMITED, Kawasaki-shi (JP)

(21) Appl. No.: 14/196,410

(22) Filed: Mar. 4, 2014

(30) Foreign Application Priority Data
Mar. 28, 2013 (JP) 2013-070688

(51) Int. Cl. G06F 3/06

(52) U.S. Cl. CPC G06F 3/0683; G06F 3/0604; G06F 3/0631
USPC 711/148

(57) ABSTRACT

An information processing device includes a processor, and a plurality of memories arranged on the processor and coupled to the processor, wherein the plurality of memories are stacked on each other, and wherein a first memory that is located farthest from the processor among the plurality of memories is allocated for a program for managing the information processing device, and the processor executes the program.

### CROSS-REFERENCE TO RELATED APPLICATION

This application is based upon and claims the benefit of priority of the prior Japanese Patent Application No. 2013-070688, filed on Mar. 28, 2013, the entire contents of which are incorporated herein by reference.

### FIELD

The embodiments discussed herein are related to an information processing device, a method for controlling an information processing device, and a program for controlling an information processing device.

### BACKGROUND

In recent years, since the speeds of central processing units (CPUs) installed in information processing devices have been increased and have almost reached the limit, the CPUs each have multiple processor cores (hereinafter referred to as “cores”) as arithmetic processing units for independently executing a calculation in the CPU and cause the cores to execute calculations in parallel. The number of cores included in a single CPU has been increased. Currently, a single CPU has several to several tens of cores.

In order to operate an information processing device, an operating system (OS) that is basic software for managing the information processing device is used. If a CPU has multiple cores, resources that are included in the information processing device and are the cores and a memory used as a storage device are used for the execution of the OS. The OS is a program that is continuously executed after a process of activating the information processing device. The cores and the memory are used also for the information processing device to execute a process of an application.

The memory is used when the OS and the application are executed. The memory consumes power by holding, writing, and reading data. When the memory consumes power, the temperature of the memory increases. If the temperature of the memory increases, the memory may be degraded. If the memory is degraded, a failure may easily occur in the memory. If the memory is failed, a failure may occur in an overall system.

As a technique for suppressing an increase in the temperature of a memory, there is a conventional technique for attaching a temperature sensor to memories, comparing the temperatures of the memories when the memories are not operated with the temperatures of the memories when the memories are operated, and sequentially using the memories in order from a memory of which an increase in the temperature is smallest. In addition, as a method for reducing power to be used by memories, there is a conventional technique for turning off a power supply for a memory until a program uses the memory, and turning on only a power supply for a memory having a bank to be used by the program when the program is executed. Japanese Laid-open Patent Publications Nos. 2011-95974 and 9-212416 are examples of related-art documents.

### SUMMARY

According to an aspect of the invention, an information processing device includes a processor, and a plurality of memories arranged on the processor and coupled to the processor, wherein the plurality of memories are stacked on each other, and wherein a first memory that is located farthest from the processor among the plurality of memories is allocated for a program for managing the information processing device, and the processor executes the program.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a hardware configuration of a computer that serves as an information processing device;

FIG. 2 is a perspective view of a CPU that has stacked memories according to a first embodiment;

FIG. 3 is a schematic view of a memory map;

FIG. 4A is a plan view of cores of the CPU that has stacked memories according to a second embodiment;

FIG. 4B is a plan view of the CPU that has the stacked memories according to the second embodiment;

FIG. 5 is a diagram illustrating relationships between physical addresses and logical addresses described on the memory map according to the second embodiment;

FIG. 6 is a block diagram illustrating the CPU according to the second embodiment;

FIG. 7 is a front view of the CPU that has stacked memories;

FIG. 8 is a flowchart of an assignment of a memory by the CPU according to the second embodiment;

FIG. 9 is a flowchart of the activation of an OS by the computer according to the second embodiment;

FIG. 10 is a diagram illustrating relationships between physical addresses and logical addresses described on the memory map according to a third embodiment;

FIG. 11 is a block diagram illustrating the CPU according to the third embodiment;

FIG. 12A is a diagram illustrating an example of the position of an OS core when the CPU has only the one OS core in the information processing device according to a fourth embodiment;

FIG. 12B is a diagram illustrating an OS memory corresponding to the OS core illustrated in FIG. 12A;

FIG. 13A is a diagram illustrating an example of the positions of OS cores when the CPU has the two OS cores;

FIG. 13B is a diagram illustrating OS memories corresponding to the OS cores illustrated in FIG. 13A;

FIG. 14A is a diagram illustrating another example of the positions of OS cores when the CPU has the two OS cores;

FIG. 14B is a diagram illustrating OS memories corresponding to the OS cores illustrated in FIG. 14A;

FIG. 15 is a block diagram of the CPU according to a fifth embodiment;

FIG. 16 is a flowchart of the activation of the OS by the computer according to the fifth embodiment and control of a power supply for a memory; and

FIG. 17 is a plan view of the CPU according to a sixth embodiment.

### DESCRIPTION OF EMBODIMENTS

In the field of high performance computing (HPC), in order to increase a communication bandwidth between a CPU and memories, a scheme in which the memories are mounted directly on a large scale integration (LSI) that has the CPU has started to be used. For example, stacked memories in which semiconductors that form memory layers are stacked are mounted on a semiconductor device that is a CPU or the like and forms a logic layer. The CPU that has the stacked memories is called a hybrid memory cube (HMC) in some cases. Since the memories are stacked on the CPU, the stacked memories may easily generate heat and is highly likely to have a high temperature.

For the conventional technique for using memories in order from a memory of which an increase in the temperature is smallest, a program that uses a memory for a long time may be assigned to the memory that actually easily generate heat and of which an increase in the temperature is accidently small at the time of a temperature measurement. In this case, the memory has a high temperature.

For the conventional technique for turning off a power supply for a memory until the program uses the memory, a power supply for a memory that is not used is turned off regardless of the execution of an OS. In HPC, a system is managed by monitoring the state of a CPU and avoiding an assignment of a job to the CPU when a failure occurs in the CPU. Thus, a program for monitoring is continuously executed under an OS by the CPU, and it is difficult to turn off a power supply for a memory without consideration of the execution of the OS. Thus, the temperature of the memory may increase.

Hereinafter, an information processing device, a method for controlling an information processing device, and a program for controlling an information processing device, which are disclosed herein, are described in detail with reference to the accompanying drawings. The information processing device, the method for controlling an information processing device, and the program for controlling an information processing device, which are disclosed herein, are not limited to the following embodiments.

### First Embodiment

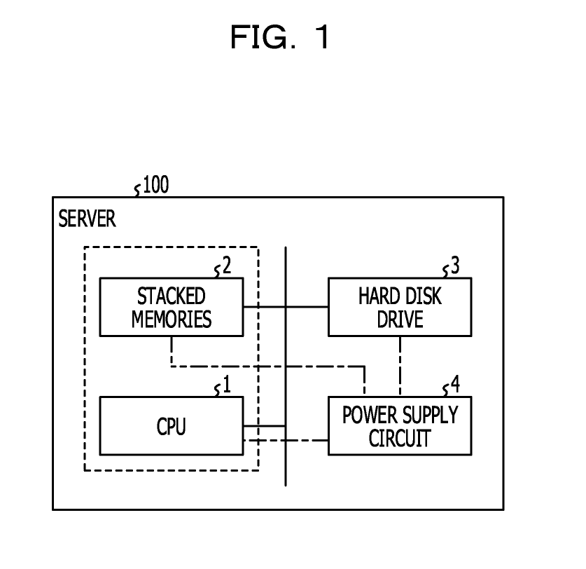

FIG. 1 is a diagram illustrating an example of a hardware configuration of a computer that serves as the information processing device. A computer 100 has a CPU 1, stacked memories 2, a hard disk drive 3, and a power supply circuit 4. The CPU 1 serves as an arithmetic processing device. The stacked memories 2 serve as a storage device. The CPU 1, the stacked memories 2, and the hard disk drive 3 are connected to each other by a bus that serves as a transmission path. Dashed lines that extend from the power supply circuit 4 to the CPU 1, the stacked memories 2, and the hard disk drive 3 represents lines for supplying power.

The stacked memories 2 that are included in the computer 100 according to a first embodiment are stacked memories composed of a plurality of stacked memory layers. The stacked memories 2 are formed on the CPU 1. In FIG. 1, a group of the CPU 1 and the stacked memories 2 that is surrounded by a broken line indicates the minimum configuration of the information processing device that includes the stacked memories 2 and the CPU 1 that has the stacked memories 2. Although FIG. 1 illustrates the single CPU 1 that has the stacked memories 2, the computer 100 may have a plurality of the CPUs 1 that each have the stacked memories 2.

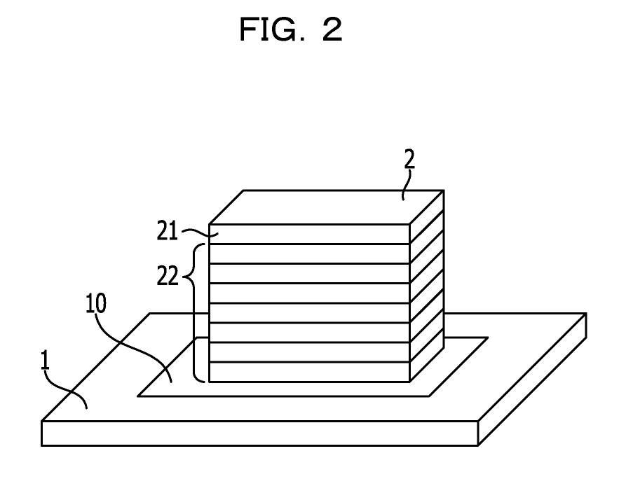

FIG. 2 is a perspective view of the CPU 1 that has the stacked memories 2 according to the first embodiment. As illustrated in FIG. 2, the CPU 1 has a single core 10. The stacked memories 2 include a memory layer 21 at the top of the stacked memories 2 in a stacking direction from the core 10. Hereinafter, the top memory layer in the stacking direction from the CPU 1 to the top of the stacked memories 2 is referred to as an “outermost layer memory”. Thus, the memory layer 21 is the outermost layer memory. The stacked memories 2 include a memory layer group 22 that has a plurality of memory layers between the memory layer 21 and the core 10.

The memory layer 21 is the outermost layer memory that does not directly contact the CPU 1. The area, contacting air, of the memory layer 21 is larger than the areas, contacting air, of the memory layers included in the memory layer group 22. Thus, a cooling efficiency of the memory layer 21 is higher than the memory layers included in the memory layer group 22.

An OS is continuously executed in the computer 100 regardless of whether or not an operator uses the computer 100 or regardless of whether or not an application specified by the operator is executed. Thus, a memory that is used by the OS continuously generates heat due to the execution of the OS. It is, therefore, preferable that a memory layer of which a cooling efficiency is highest be assigned as the memory used by the OS in order to cool the memories. The OS is an example of a “predetermined program”.

The CPU 1 according to the first embodiment assigns the memory layer 21 (that is the outermost layer memory) as the memory used by the OS. A specific method for assigning a memory by the CPU 1 is described below. The first embodiment describes the case where addresses of the stacked physical memories 2 are assigned in the order of increasing number of the addresses and in order from a memory located on the CPU 1 to the memory located at the top of the stacked memories 2.

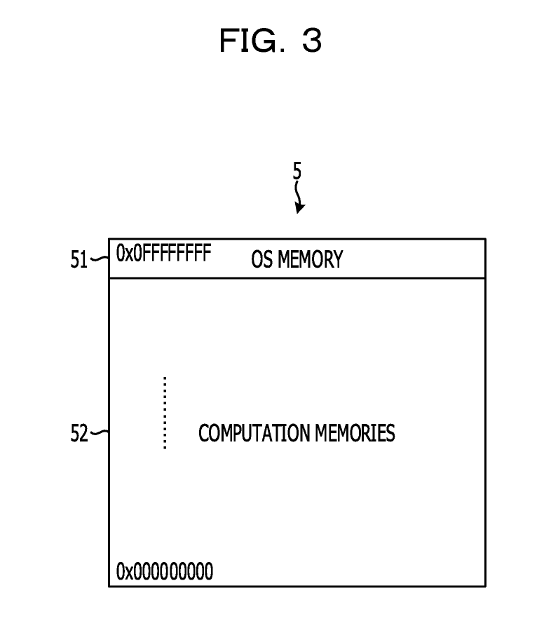

The CPU 1 accesses the stacked memories 2 using a memory map 5 illustrated in FIG. 3. FIG. 3 is a schematic view of the memory map 5. The memory map 5 represents logical addresses assigned in ascending order from the bottom part of the memory map 5 to the top part of the memory map 5. The memory map 5 directly corresponds the physical addresses of the stacked memories 2 illustrated in FIG. 2. Specifically, the memory map 5 has the logical addresses assigned in the same order as that of the physical addresses of the stacked memories 2 from the memory located on the CPU 1 to the memory located at the top of the stacked memories 2, while the physical addresses are assigned to the stacked memories 2 illustrated in FIG. 2.

The CPU 1 stores an address range 51 of the memory map 5 as a memory pool of an OS memory region (system region) that is used by the OS. In addition, the CPU 1 stores an address range 52 of the memory map 5 as a memory pool of a computation memory region (user memory region) that is used by an application such as a simulation application. In the first embodiment, a boundary between the address range 51 and the address range 52 is fixed. The address range 51 is a region that includes an address that has the largest value among the addresses described on the memory map 5. The address range 51 corresponds to physical addresses of the memory layer 21 of the stacked memories 2 illustrated in FIG. 1. Although only the memory layer 21 that is the outermost layer memory is used as the memory pool of the OS memory region in the first embodiment as an example, the amount of the memory pool of the OS memory region is not limited to this. For example, memory layers that are included in a predetermined range from the memory layer 21 (that is the outermost layer memory) to a memory layer included in the memory layer group 22 and located on the side of the CPU 1 may be used as the memory pool of the OS memory region.

When the CPU 1 receives a request to secure a memory from the OS to be activated, the CPU 1 references the memory map 5 and assigns the memory that corresponds to the address range 51 and is used as the memory pool of the OS memory region. Since the addresses in the address range 51 correspond to the physical addresses of the memory layer 21 that is the outermost layer memory of the stacked memories 2, the CPU 1 assigns, as the OS memory region, the memory within the memory layer 21.

After that, the CPU 1 executes the OS using the memory region assigned as the OS memory region and included in the memory layer 21.

The CPU 1 assigns an address of a memory region in order to execute the application such as the simulation application, while the assigned address of the memory region is in the address range 52 that is described on the memory map 5 illustrated in FIG. 3 and is used as the memory pool of the computation memory region. Since addresses in the address range 52 correspond to the physical addresses of the memory layer group 22 of the stacked memories 2, the CPU 1 assigns the memory region included in the memory layer group 22 as the computation memory region. Then, the CPU 1 uses the memory region assigned as the computation memory region and included in the memory layer group 22 and executes the application.

As described above, the information processing device according to the first embodiment assigns, as the OS memory region, the memory region included in the outermost layer memory. Thus, the CPU 1 executes the OS using the memory region included in the outermost layer memory. The memory that is used to execute the OS is included in the stacked memories 2 and has a high cooling efficiency among the stacked memories 2. The memory that has the high cooling efficiency is used as the OS memory region and continuously generates heat, while the other memories are used only when the application or the like is executed. It may be therefore possible to improve the cooling efficiency of the overall stacked memories 2, maintain the temperatures of the stacked memories 2 at low levels, and improve the service life of the stacked memories 2.

### Second Embodiment

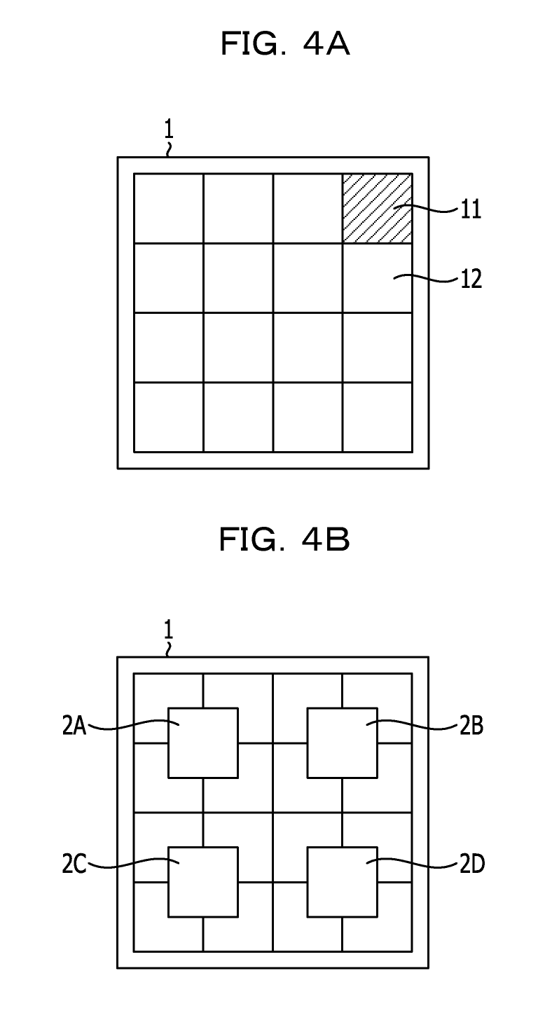

FIG. 4A is a plan view of cores of the CPU 1 that has stacked memories 2A to 2D according to a second embodiment. FIG. 4B is a plan view of the CPU 1 that has the stacked memories 2A to 2D according to the second embodiment.

As illustrated in FIG. 4A, the CPU 1 according to the second embodiment is a multicore CPU provided with multiple cores that are a core 11 (indicated by diagonal lines) and a core 12 that is different from the core 11.

If a certain core of the CPU 1 executes a calculation for a process of the application and a process of the OS interrupts the certain core, it may be difficult for the CPU 1 to increase an overall calculation speed due to the process that interrupts the certain core. In recent years, in a CPU that has multiple cores, a specific core is used to execute an OS. When the specific core 11 is used to execute the OS, a process of the OS does not interrupt the core 12 that executes a calculation for a process of an application, and the CPU 1 may execute the calculation at a higher speed. Even if a small number of cores are assigned to the OS and dedicated to the OS, the speed of the calculation for the process of the application is increased. Thus, the overall calculation speed of the information processing device is increased.

In the second embodiment, the CPU 1 uses the core 11 of the CPU 1 as an OS core that executes the OS. In addition, the CPU 1 uses the core 12 (different from the core 11) of the CPU 1 as a computing core that executes the application.

As illustrated in FIG. 4B, the four groups of stacked memories 2A to 2D are mounted on the CPU 1.

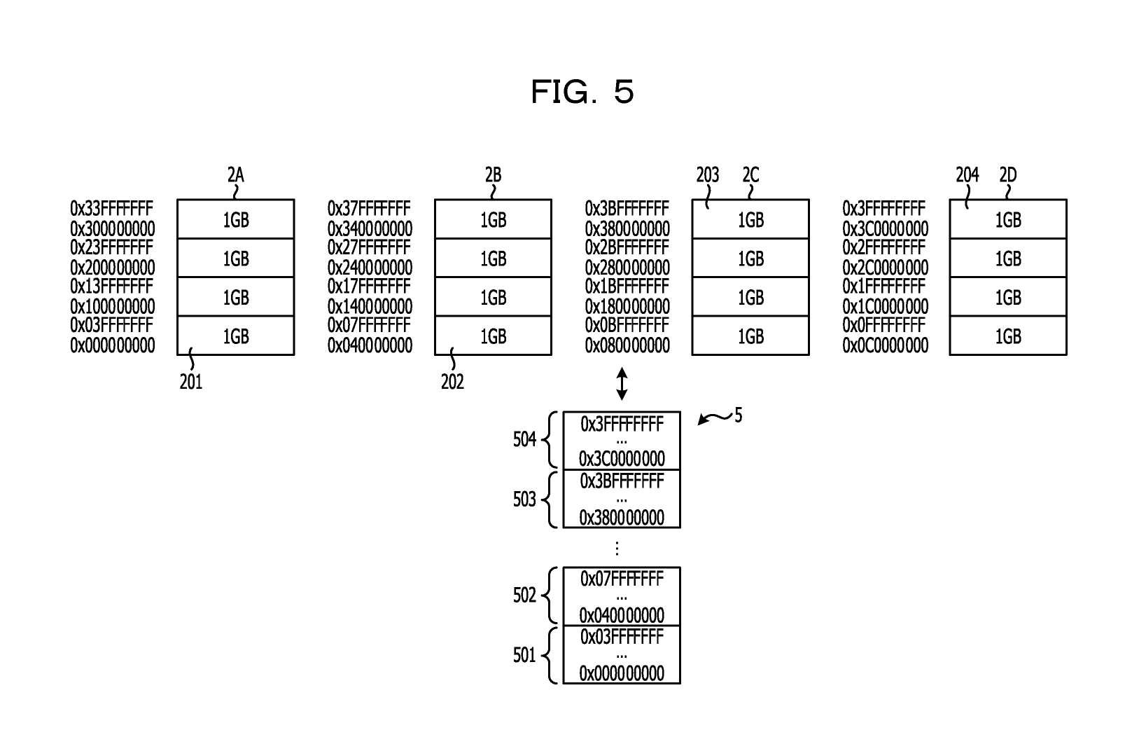

FIG. 5 is a diagram illustrating relationships between physical addresses and logical addresses described on the memory map 5 according to the second embodiment. FIG. 5 illustrates the memories 2A to 2D stacked on the CPU 1. Addresses illustrated on the left sides of memory layers of the stacked memories 2A to 2D are physical addresses of the memory layers. Hereinafter, the side on which the CPU 1 is located is referred to as the “lower side” of the stacked memories 2A to 2D, and the opposite side of the side on which the CPU 1 is located is referred to as the “upper side” of the stacked memories 2A to 2D.

In the second embodiment, the first address is assigned to a memory of the lowermost layer of the stacked memories 2A, the second address that is next to the first address is assigned to a memory of the lowermost layer of the stacked memories 2B, the third address that is next to the second address is assigned to a memory of the lowermost layer of the stacked memories 2C, and the fourth address that is next to the third address is assigned to a memory of the lowermost layer of the stacked memories 2D. Then, addresses are assigned to memories of the second lowermost layers of the stacked memories 2A to 2D in the order of the stacked memories 2A, 2B, 2C, and 2D. Then, the last address is assigned to a memory of the uppermost layer of the stacked memories 2D.

In the present embodiment, the CPU 1 accesses the memories 2A to 2D using the memory map 5 illustrated in FIG. 5. On the memory map 5, the logical addresses are assigned in order from the bottom to top of the memory map 5. Specifically, a value of the address described at the bottom of the memory map 5 is smallest, while a value of the address indicated at the top of the memory map 5 is largest. The logical addresses are the same as physical addresses of the stacked memories 2A to 2D.

When the physical addresses are assigned to the stacked memories 2A to 2D and the logical addresses are described on the memory map 5, a logical address range 504 for 1 GB that is described at the top of the memory map 5 corresponds to physical addresses of a memory 204 of the uppermost memory layer of the stacked memories 2D, for example. A logical address range 503 for 1 GB that is continuous to the logical address range 504 on the memory map 5 corresponds to physical addresses of a memory 203 of the uppermost memory layer of the stacked memories 2C, for example. A logical address range 501 for 1 GB that is described at the bottom of the memory map 5 corresponds to physical addresses of a memory 201 of the lowermost memory layer of the stacked memories 2A, for example. A logical address range 502 for 1 GB that is continuous to the logical address range 501 on the memory map 5 corresponds to physical addresses of a memory 202 of the lowermost memory layer of the stacked memories 2B, for example.

In the second embodiment, the logical address range 504 (for 1 GB) of which the addresses correspond to the memory 204 of the stacked memories 2D and of which a range of values of the addresses is largest among the logical ranges described on the memory map 5 is used as the memory pool of the OS memory region. Since the logical address range 504 corresponds to the physical addresses of the memory 204 of the stacked memories 2D, the OS memory region that is included in the memory 204 is assigned.

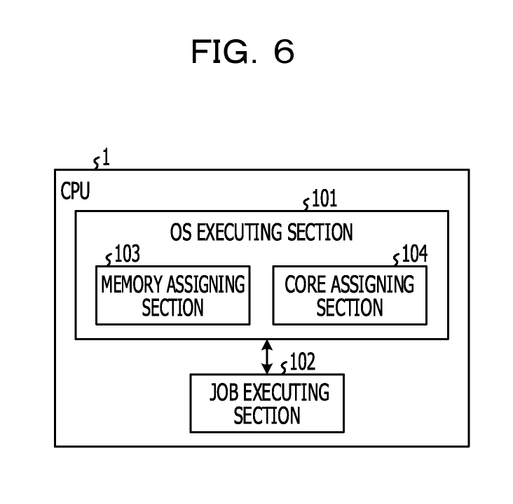

FIG. 6 is a block diagram of the CPU 1 according to the second embodiment. As illustrated in FIG. 6, the CPU 1 has an OS executing section 101 and a job executing section 102. The OS executing section 101 has a memory assigning section 103 and a core assigning section 104.

When power is supplied to the computer 100, the OS executing section 101 activates a basic input and output system (BIOS). The OS executing section 101 causes the activated BIOS to diagnose the stacked memories 2A to 2D, the hard disk drive 3, and the like.

Next, the OS executing section 101 causes the BIOS to load a boot loader into a predetermined fixed region of the stacked memories 2A to 2D. Then, the OS executing section 101 activates the boot loader. The boot loader has information that indicates a start address among logical addresses of the OS memory region and is to be used to load a kernel image included in the OS. In the second embodiment, the boot loader has information of a predetermined address range included in the logical address range 504 described on the memory map 5.

Next, the OS executing section 101 loads the kernel image of the OS into a memory region corresponding to logical addresses described in the boot loader and included in the OS memory region. In the second embodiment, the kernel image is loaded in the memory 204 of the stacked memories 2D. Then, the OS executing section 101 executes the kernel loaded in the memory 204.

Then, the OS executing section 101 causes the kernel to start activating the OS. The OS executing section 101 acquires, from the core assigning section 104, identification information of the core 11 that is the OS core. After that, a function of the OS executing section 101 is executed by the core 11 corresponding to the identification information acquired from the core assigning section 104.

In addition, the OS executing section 101 acquires, from the memory assigning section 103, a logical address of the memory region to be assigned to the OS. In the second embodiment, the OS executing section 101 acquires an address from the logical address range 504 described on the memory map 5.

Then, the OS executing section 101 activates the OS using a memory having a physical address corresponding to the acquired logical address. After that, if a memory is to be used for processes of the OS, the OS executing section 101 acquires, from the memory assigning section 103, a logical address of the memory to be used and executes the processes using the memory having a physical address corresponding to the acquired logical address. In the second embodiment, the OS executing section 101 uses the memory 204 of the stacked memories 2D to activate the OS and executes the various processes of the OS. Specifically, the OS executing section 101 uses the outermost layer memory having the highest cooling efficiency and included in the stacked memories 2D and thereby executes the processes of the OS.

The OS executing section 101 receives an entry of a job from the operator and cause the core 12 (other than the core 11 executing the OS) to execute the job assigned to the job executing section 102. In this case, the OS executing section 101 acquires, from the memory assigning section 103, a logical address of a memory region used by the job executing section 102 and notifies the job executing section 102 of the acquired logical address. The value of the logical address, acquired by the OS executing section 101, of the memory region used by the job executing section 102 is smaller than the logical address range 504 described on the memory map 5.

The core assigning section 104 holds identification information of the core 11 used as the OS core. When the activation of the OS is started, the core assigning section 104 receives, from the OS executing section 101, a request to transmit a notification indicating information of the core 11 used for the execution of the OS. Then, the core assigning section 104 notifies the OS executing section 101 of the identification information of the core 11.

The memory assigning section 103 has the memory map 5. The memory assigning section 103 stores information indicating that the logical address range 504 is used as the memory pool of the OS memory region among the logical address ranges described on the memory map 5. When the activation of the OS is started, the memory assigning section 103 receives, from the OS executing section 101, a request to assign a memory region to be used for the activation of the OS. Then, the memory assigning section 103 determines a logical address that is among logical addresses of an available memory region included in the memory region corresponding to the logical address range 504 and is to be used for the activation of the OS. The memory assigning section 103 notifies the OS executing section 101 of the determined logical address. When a memory region is used for the execution of the processes of the OS, the memory assigning section 103 receives, from the OS executing section 101, a request to assign the memory region to be used for the execution of the processes of the OS. Then, the memory assigning section 103 determines a logical address that is among logical addresses of an available memory region included in the memory region corresponding to the logical address range 504 and is to be used for the activation of the OS. Then, the memory assigning section 103 notifies the OS executing section 101 of the determined logical address. When notifying the OS executing section 101 of a logical address to be used, the memory assigning section 103 stores the notified logical address.

When a job is entered, the memory assigning section 103 receives, from the OS executing section 101, a request to assign a memory for the job. Then, the memory assigning section 103 determines a logical address of a memory that is not in the logical address range 504 (that is the memory pool of the OS memory region) and is to be used for the execution of the job. In other words, the memory assigning section 103 determines the logical address of the memory to be used for the execution of the job, while the value of the logical address is smaller than the logical address range 504 on the memory map 5. Next, the memory assigning section 103 notifies the OS executing section 101 of the determined logical address.

When the job is entered, the job executing section 102 receives, from the OS executing section 101, an instruction to execute the job and the logical address of the memory to be used for the job. The value of the logical address that is received by the job executing section 102 from the OS executing section 101 is equal to or smaller than the value of an address in the logical address range 503 described on the memory map 5. Then, the job executing section 102 executes the job specified for the OS executing section 101 using a memory having a physical address corresponding to the notified logical address. Specifically, the job executing section 102 executes the job using the memory other than the memory region 204 of the stacked memories 2D.

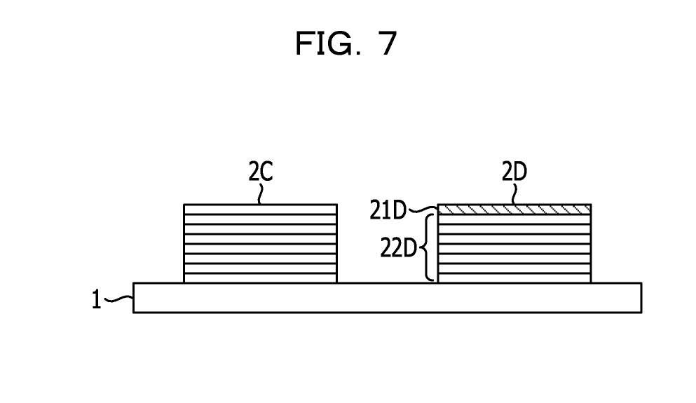

Next, assignment states of the physical memories included in the information processing device according to the second embodiment are described with reference to FIG. 7. FIG. 7 is a front view of the CPU 1 that has the stacked memories.

When receiving a request to assign a memory for the activation of the OS and the execution of the processes of the OS from the OS executing section 101, the memory assigning section 103 determines a logical address that is in the logical address range 504 described on the memory map 5 (illustrated in FIG. 5) and to be used. Then, the OS executing section 101 acquires the logical address determined by the memory assigning section 103. In this case, the OS executing section 101 acquires the logical address in the logical address range 504 described on the memory map 5.

Then, the OS executing section 101 uses a memory region having a physical address corresponding to the acquired logical address and thereby activates the OS and executes the other processes. The memory region that has the physical address corresponding to the logical address in the logical address range 504 of the memory map 5 is a memory region included in the memory 204 of the stacked memories 2D as illustrated in FIG. 5. The memory 204 is the outermost layer memory of the stacked memories 2D. Specifically, the OS executing section 101 activates the OS and executes the other processes using a memory layer 21D (illustrated in FIG. 7) that is the outermost layer memory of the stacked memories 2D. Thus, the memory layer 21D that is the outermost layer memory is used for the execution of the OS.

When receiving a request to assign a memory for the execution of a job from the OS executing section 101, the memory assigning section 103 determines logical addresses that are to be used and in the logical address ranges 501 to 503 other than the logical address range 504 described on the memory map 5 illustrated in FIG. 5. Then, the OS executing section 101 acquires the logical addresses determined by the memory assigning section 103. In this case, the OS executing section 101 acquires the logical addresses in the logical address ranges 501 to 503.

Then, the OS executing section 101 uses a memory region having physical addresses corresponding to the acquired logical addresses and thereby executes the job and another process. The memory region that has the physical addresses corresponding to the logical addresses in the logical address ranges 501 to 503 is a memory region that is not the memory 204 of the stacked memories 2D and is included in the stacked memories 2A to 2D as illustrated in FIG. 5. Specifically, the OS executing section 101 executes the job and the other process using memory layers 22D (illustrated in FIG. 7) of the stacked memories 2D and the stacked memories 2A to 2C. Thus, the memory layers other than the memory layer 21D (that is the outermost layer memory) are used for execution (other than the execution of the OS) such as the execution of the job.

In this manner, the memory layer 21D that is the outermost layer memory and has a high cooling efficiency is assigned as the OS memory region that is used for the execution of the OS and thereby generates a large amount of heat. In addition, the memory layers other than the outermost layer memory are assigned as computation memories that are used for the execution of a job. Thus, heat generated due to the execution of the OS may be efficiently cooled, and it may be possible to suppress generation of heat of the overall stacked memories 2A to 2D.

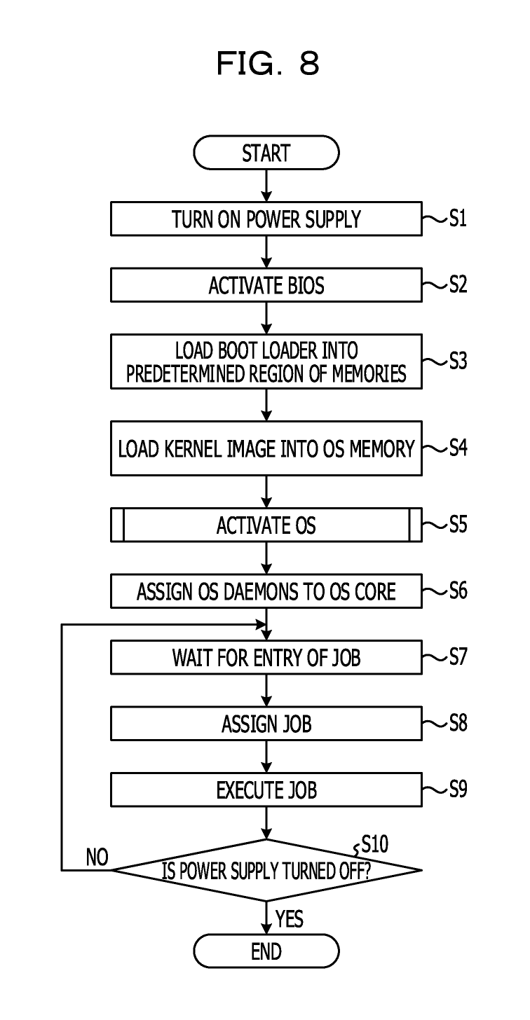

Next, an assignment of a memory by the CPU 1 according to the second embodiment is described with reference to FIG. 8. FIG. 8 is a flowchart of the assignment of the memory by the CPU 1 according to the second embodiment. The case where Linux (registered trademark) is used as the OS is described below.

First, the CPU 1 detects that a power supply for the computer 100 is turned on by the operator (in step S1).

When the power supply is turned on, the CPU 1 activates the basic input and output system (BIOS) (in step S2). The CPU 1 causes the BIOS to execute a diagnostic test on the stacked memories 2A to 2D, the hard disk drive 3, and the like.

The CPU 1 causes the BIOS to load the boot loader into a predetermined region of the stacked memories 2A to 2D (in step S3).

The CPU 1 causes the boot loader to load the kernel image into the memory 204 that is the OS memory region and is the outermost layer memory of the stacked memories 2D (in step S4).

The CPU 1 causes the loaded kernel to activate various daemons using the memory 204 (that is the OS memory and is the outermost layer memory of the stacked memories 2D) and thereby activates the OS (in step S5).

After that, the CPU 1 causes the OS to assign the daemons to the core 11 for the OS using a taskset command (in step S6). For example, the taskset command is described in an rc script, and the assignment of the daemons to the core 11 is executed using the taskset command during the execution of the rc script. The rc script is a program that sequentially executes a series of basic settings of the computer upon the activation, while the basic settings include setting of a network and setting of an assignment of a memory.

The CPU 1 waits for an entry of a job (in step S7). Next, the CPU 1 receives a request to assign a job from the operator and assigns the job specified by the operator to the computing core 12 (in step S8). The computing core 12 of the CPU 1 executes the assigned job (in step S9).

After that, the CPU 1 determines whether or not the power supply for the computer 100 has been turned off by the operator (in step S10). If the power supply is not turned off (No in step S10), the CPU 1 causes the process to return to step S7 and stands by until a job is entered. If the power supply has been turned off (Yes in step S10), the CPU 1 shuts down the OS and stops the computer 100.

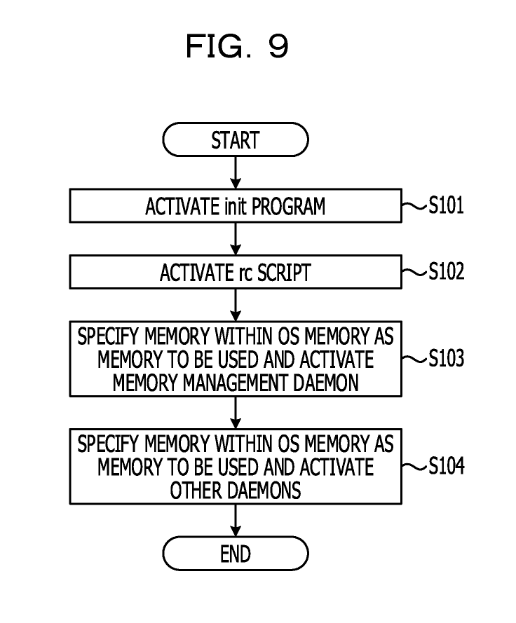

Next, the activation of the OS is described with reference to FIG. 9. FIG. 9 is a flowchart of the activation of the OS by the computer 100 according to the second embodiment. The flowchart of FIG. 9 is an example of the process of step S5 illustrated in FIG. 8. Processes of the flowchart of FIG. 9 are achieved by causing the CPU 1 to execute various programs using the memory 204 upon the activation of the OS. The execution of the various programs by the CPU 1 upon the activation of the OS is mainly described below.

First, the kernel activates init (in step S101). For the kernel, an address that is among the addresses of the memory 204 for the OS is specified as setting for the activation of init. Since the order of the logical addresses described on the memory map 5 corresponds to the order of the physical addresses, the address specified for the kernel may be any of a logical address and a physical address. The kernel activates init using a memory region corresponding to the specified address and included in the memory 204. Then, init activates the rc script (in step S102).

In the rc script, an address that is among the addresses of the memory 204 for the OS and used for the activation of a memory management daemon is specified. The rc script activates the memory management daemon using a memory corresponding to the specified address among the addresses of the memory 204 (in step S103).

In addition, the rc script starts activating a network management daemon and a system management daemon as well as the memory management daemon. In this case, the memory management daemon acquires a logical address of a memory to be used for the activation of the daemons from the logical address range 504 corresponding to the memory pool of the OS memory region and described on the memory map 5. Then, the memory management daemon causes the memory included in the memory 204 and having a physical address corresponding to the acquired logical address to be used for the activation of the daemons (in step S104).

The second embodiment describes the case where the memory 204 that is the outermost layer memory of the stacked memories 2D illustrated in FIG. 5 is used as the OS memory region. However, at least any of the outermost layer memories of the stacked memories 2A to 2C may be used as the OS memory region as long as the OS uses the memory of 1 GB or larger.

For example, the logical address range 503 that corresponds to the physical addresses of the outermost layer memory of the stacked memories 2C is described under the logical address range 504 on the memory map 5 illustrated in FIG. 5. In addition, the logical address range 502 that corresponds to the physical addresses of the outermost layer memory of the stacked memories 2B is described under the logical address range 503 on the memory map 5. The logical address range 501 that corresponds to the physical addresses of the outermost layer memory of the stacked memories 2A is described under the logical address range 502 on the memory map 5. For example, the CPU 1 may use, as OS memory regions, memory regions corresponding to an upper part of the memory map 5 and having a capacity of 4 GB and thereby assign the outermost layer memories of the stacked memories 2A to 2D as the OS memory regions.

As described above, the information processing device according to the second embodiment uses the outermost layer memory of at least one of the stacked memories as the OS memory region. In addition, the information processing device according to the second embodiment uses, as the computation memory region to be used to execute a job, a memory other than the memory used as the OS memory region. Thus, the information processing device according to the second embodiment may assign, as the OS memory region continuously generating heat, the outermost layer memory with a higher cooling efficiency than the memories of the other layers of the stacked memories and maintain the temperatures of the memories at low levels. In addition, the information processing device according to the second embodiment may maintain the temperatures of the memories at low levels, suppress failure rates of the memories, and improve the service life of the memories.

### Third Embodiment

Next, a third embodiment is described. The third embodiment is different from the first embodiment in that a memory management unit (MMU) is used to translate logical addresses to physical addresses in the third embodiment. Hereinafter, a description of parts that have the same functions as those described in the first embodiment is omitted.

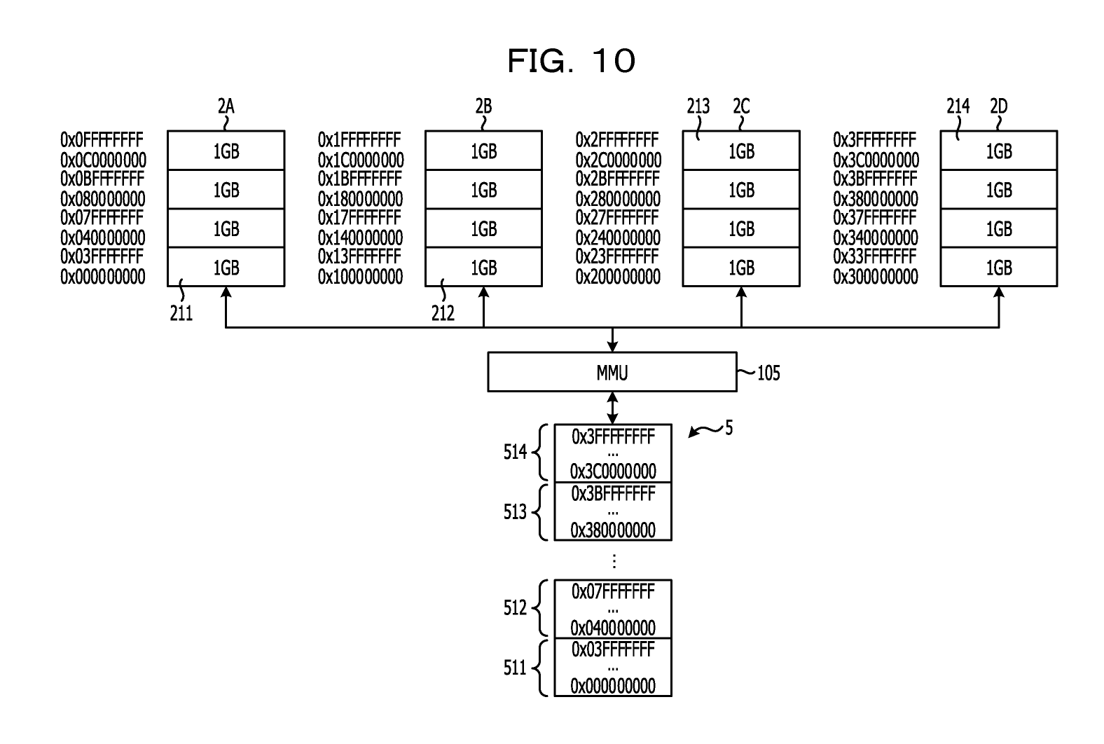

FIG. 10 is a diagram illustrating relationships between physical addresses and logical addresses described on the memory map 5 according to the third embodiment. FIG. 10 illustrates the memories 2A to 2D stacked on the CPU 1 as described with reference to FIG. 5. Addresses that are illustrated on the left sides of the memory layers of the stacked memories 2A to 2D are physical addresses of the memories of the layers. Hereinafter, the side on which the CPU 1 is located is referred to as the “lower side” of the stacked memories 2A to 2D, and the opposite side of the side on which the CPU 1 is located is referred to as the “upper side” of the stacked memories 2A to 2D.

In the third embodiment, sequential physical addresses are assigned to each of the stacked memories 2A to 2D, and the physical addresses assigned to the stacked memories 2A to 2D are sequential. For example, an address of which the value is smallest is assigned to the lowermost part of the stacked memories 2A. The value of an address increases toward the uppermost part of the stacked memories 2A. An address assigned to the lowermost part of the stacked memories 2B is next to an address of the uppermost part of the stacked memories 2A.

As illustrated in FIG. 10, it is assumed that the physical addresses are assigned to the stacked memories 2A to 2D and that the memory map 5 on which the logical addresses of which the values increase from the bottom part of the memory map 5 toward the top part of the memory map 5 are described in the same manner as the second embodiment is used. Based on this assumption, not all physical addresses that are assigned to the outermost layer memories of the staked memories 2A to 2D are described at the top part of the memory map 5. Thus, if the CPU 1 recognizes upper several GB of the memory map 5 as the memory pool of the OS memory region, the CPU 1 may use a memory layer other than the outermost layer memories of the stacked memories 2A to 2D as the OS memory region. In this case, the memory other than the outermost layer memories is used as the OS memory region that generates a large amount of heat, and the memories may not be efficiently cooled.

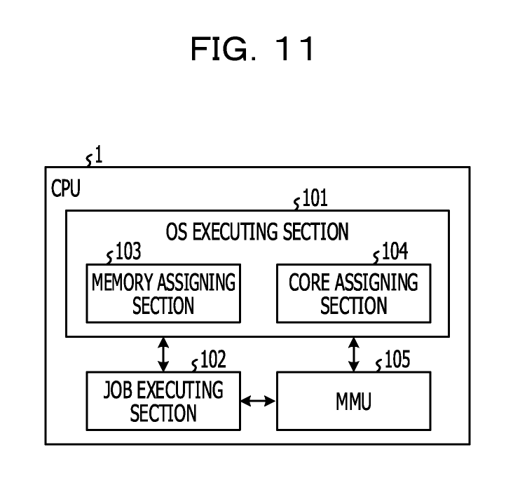

To avoid this, the CPU 1 according to the third embodiment has the sections 101 to 104 described in the second embodiment and an MMU 105 that controls associations between the logical addresses of the memories and the physical addresses of the memories as illustrated in FIG. 11. FIG. 11 is a block diagram of the CPU 1 according to the third embodiment.

The MMU 105 associates a logical address range 511 for 1 GB that is the smallest range on the memory map 5 with physical addresses of a memory 211 of the stacked memories 2A, for example. Specifically, when receiving information specifying a logical address in the logical address range 511, the MMU 105 translates the specified logical address to a physical address of the memory 211. In addition, the MMU 105 translates a physical address of the memory 211 to a logical address in the logical address range 511.

The MMU 105 associates a logical address range 512 for 1 GB that is next to the logical address range 511 on the memory map 5 with physical addresses of a memory 212 of the stacked memories 2B, for example. In addition, the MMU 105 associates logical addresses in logical address ranges 513 and 514 next to the logical address range 512 on the memory map 5 with physical addresses of memories of the stacked memories 2C and 2D in order from the memory of the lowermost layer of the stacked memories 2C to the memory of the lowermost layer of the stacked memories 2D. The MMU 105 associates the logical addresses described on the memory map 5 with the physical addresses of the memory layers of the stacked memories 2A to 2D in the order of the stacked memories 2A, 2B, 2C, and 2D and in order from the lowermost memory layers of the stacked memories 2A to 2D to the uppermost memory layers of the stacked memories 2A to 2D on a memory layer basis.

Since the logical addresses described on the memory map 5 are associated with the physical addresses in the aforementioned manner, the MMU 105 associates logical addresses for upper 4 GB that are described on the memory map 5 with the outermost layer memories of the stacked memories 2A to 2D, for example. Operations of the MMU 105 that uses the associations of the logical addresses with the physical addresses are described below.

The MMU 105 receives, from the OS executing section 101, a request to read and write data and information specifying a logical address that is in the logical address range 514 for upper 1 GB and described on the memory map 5. Then, the MMU 105 translates the specified logical address to a physical address. In this case, the MMU 105 acquires, for the data to be read and written, a physical address within the memory 214 that is the outermost layer memory of the stacked memories 2D. Then, the MMU 105 reads and writes the data at the acquired physical address within the memory 214.

The MMU 105 receives, from the job executing section 102, a request to read and write data and information specifying a logical address that is not in the logical address range 514 and is described on the memory map 5. Then, the MMU 105 translates the specified logical address to a physical address. In this case, the MMU 105 acquires, for the data to be read and written, a physical address among the physical addresses assigned to the memories other than the memory 214. Then, the MMU 105 reads and writes the data at the acquired physical address.

When receiving a request to assign a memory from the OS executing section, the memory assigning section 103 acquires a logical address that is to be used and is in the logical address range 514 for upper 1 GB on the memory map 5. Then, the memory assigning section 103 notifies the OS executing section 101 of the acquired logical address.

When receiving a request to assign a memory from the job executing section 102, the memory assigning section 103 acquires a logical address that is to be used and is not in the logical address range 514 described on the memory map 5. Then, the memory assigning section 103 notifies the OS executing section 101 of the acquired logical address.

The OS executing section 101 notifies the memory assigning section 103 of a request to assign a memory for the activation of the OS and the execution of the processes of the OS. After that, the OS executing section 101 acquires, from the memory assigning section 103, a logical address in the logical address range 514 as the memory to be used to activate the OS and execute the processes of the OS. Then, the OS executing section 101 notifies the MMU 105 of an instruction to read and write data at the logical address acquired from the memory assigning section 103.

The job executing section 102 notifies the memory assigning section 103 of a request to assign a memory for the execution of a job. After that, the job executing section 102 acquires, from the memory assigning section 103, a logical address that is not in the logical address range 514 and is used for the memory to be used to execute the job. Then, the job executing section 102 notifies the MMU 105 of an instruction to read and write the data at the logical address acquired from the memory assigning section 103.

The third embodiment describes the case where the physical addresses are assigned to the stacked memories 2A to 2D as illustrated in FIG. 10. A method for assigning the physical addresses is not limited to this. Regardless of how the physical addresses are assigned, when the MMU 105 translates a logical address range specified as the OS memory region to a physical address of the outermost layer memory of at least one of the stacked memories 2A to 2D, the OS may be executed using the outermost layer memory of the at least one of the stacked memories 2A to 2D.

As described above, the information processing device according to the third embodiment uses the MMU 105 to translate a logical address specified as the OS memory region to a physical address of the outermost layer memory of at least one of the stacked memories 2A to 2D. In addition, the information processing device according to the third embodiment uses the MMU 105 to translate a logical address specified as a computation memory to a physical address of a memory other than a memory used as the OS memory region. Thus, the information processing device according to the third embodiment assigns, as the OS memory region, at least one of the outermost layer memories with a higher cooling efficiency than the memories of the other layers of the stacked memories and may improve the cooling efficiency of the overall memories, regardless of a method for assigning the physical addresses to the stacked memories.

### Fourth Embodiment

Next, a fourth embodiment is described. The fourth embodiment is different from the second embodiment in that an outermost layer memory of stacked memories that are closest to a core that executes the OS is used as the OS memory region in fourth embodiment. Hereinafter, an assignment of the OS memory region is mainly described. The CPU 1 according to the fourth embodiment is illustrated in the block diagram of FIG. 6. Hereinafter, a description of parts that have the same functions as those described in the second embodiment is omitted.

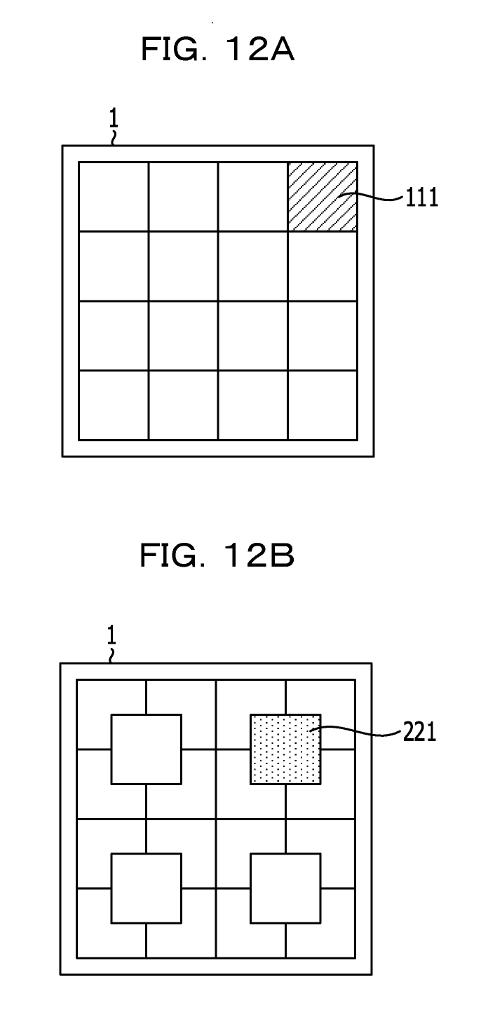

FIG. 12A is a diagram illustrating an example of the position of an OS core 111 when the number of OS cores is 1 in the information processing device according to the fourth embodiment. FIG. 12B is a diagram illustrating an OS memory corresponding to the OS core 111 illustrated in FIG. 12A.

In the information processing device according to the fourth embodiment, the core assigning section 104 stores information indicating that the core 111 is used as the OS core. The core assigning section 104 specifies the core 111 illustrated in FIG. 12A as the OS core when the OS executing section 101 activates the OS.

The memory assigning section 103 stores, as the memory pool of the OS memory, a logical address corresponding to a physical address of an outermost layer memory of stacked memories 221 that are closest to the core 111 and illustrated in FIG. 12B.

When receiving, from the OS executing section 101, a request to assign a memory to be used for the activation of the OS and the execution of the processes of the OS, the memory assigning section 103 acquires a logical address in a logical address range corresponding to the physical outermost layer memory of the stacked memories 221. Then, the memory assigning section 103 notifies the OS executing section of the acquired logical address.

When receiving, from the job executing section 102, a request to assign a memory to be used for the execution of a job, the memory assigning section 103 acquires a logical address in a logical address range corresponding to physical memories other than the outermost layer memory of the stacked memories 221. Then, the memory assigning section 103 notifies the job executing section 102 of the acquired logical address.

The case where the number of OS cores is 1 is described with reference to FIGS. 12A and 12B. The number of OS cores, however, may be two or more. Next, examples of correspondences between a plurality of OS cores and memories are described.

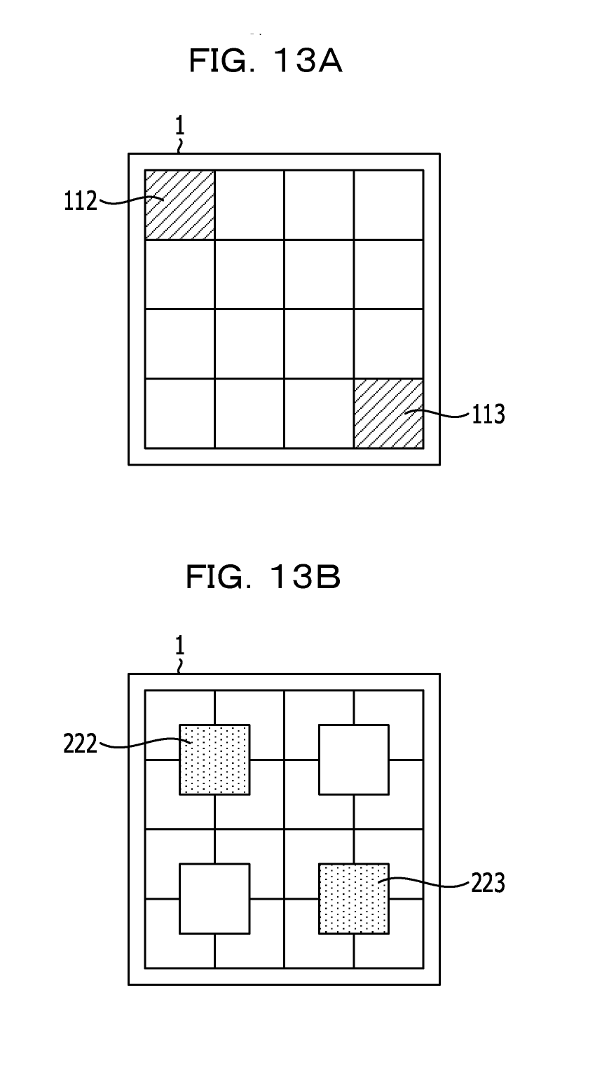

FIG. 13A is a diagram illustrating an example of the positions of OS cores 112 and 113 when the number of OS cores is 2 in the information processing device according to the fourth embodiment. FIG. 13B is a diagram illustrating OS memories corresponding to the OS cores 112 and 113 illustrated in FIG. 13A.

In the example illustrated in FIG. 13A, the core assigning section specifies the cores 112 and 113 illustrated in FIG. 13A as OS cores.

In this case, the memory assigning section 103 specifies, as a memory to be used for the core 112 to execute the OS, an outermost layer memory of stacked memories 222 that are closest to the core 112 and illustrated in FIG. 13B. In addition, the memory assigning section 103 specifies, as a memory to be used for the core 113 to execute the OS, an outermost layer memory of stacked memories 223 that are closest to the core 113 and illustrated in FIG. 13B.

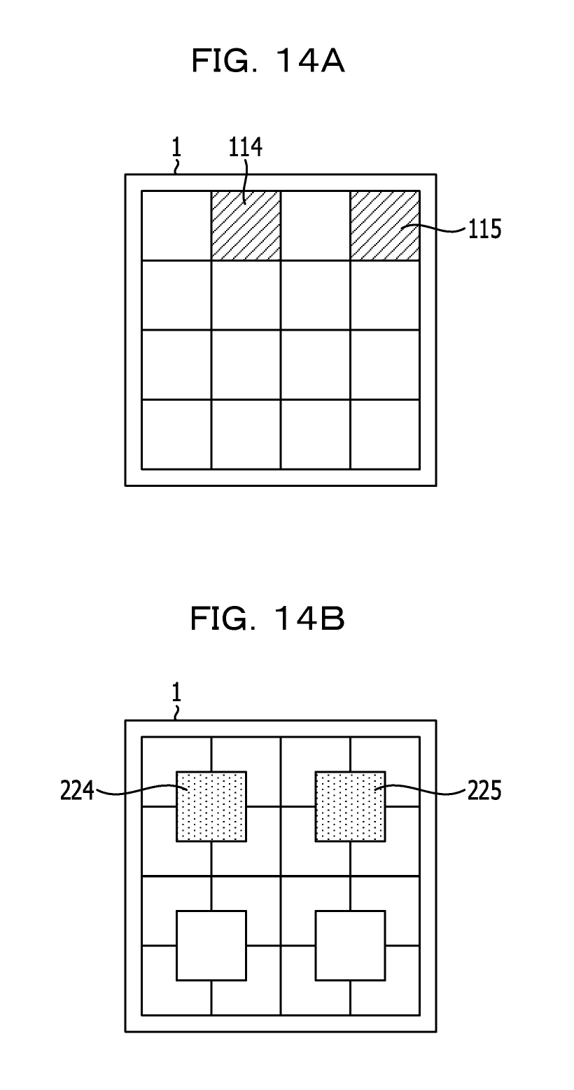

FIG. 14A is a diagram illustrating another example of the positions of OS cores 114 and 115 when the number of OS cores is 2 in the information processing device according to the fourth embodiment. FIG. 14B is a diagram illustrating OS memories corresponding to the OS cores 114 and 115 illustrated in FIG. 14A.

In the example illustrated in FIG. 14A, the core assigning section 104 specifies the cores 114 and 115 illustrated in FIG. 14A as OS cores.

In this case, the memory assigning section 103 specifies, as a memory to be used for the core 114 to execute the OS, an outermost layer memory of stacked memories 224 that are closest to the core 114 and illustrated in FIG. 14B. In addition, the memory assigning section 103 specifies, as a memory to be used for the core 115 to execute the OS, an outermost layer memory of stacked memories 225 that are closest to the core 115 and illustrated in FIG. 14B.

As described above, the information processing device according to the fourth embodiment uses, as an OS memory, an outermost layer memory of stacked memories that are closest to an OS core. Thus, the OS core that executes the OS and the OS memory to be used for the execution of the OS may be arranged in a single place. It may be therefore possible to suppress the amount of heat generated by the other parts arranged on the CPU 1. In addition, since the memory of the outermost layer is used as the OS memory, it may be possible to suppress generation of heat from the memory due to the execution of the OS and maintain the temperature of the memory at a low level.

### Fifth Embodiment

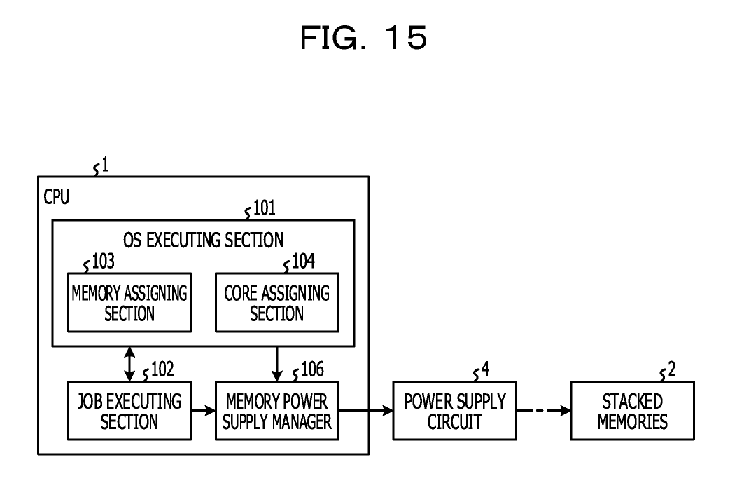

Next, a fifth embodiment is described. The fifth embodiment is different from the second embodiment in that a power supply for a computation memory that is used for the execution of a job is turned off until the job uses the memory in the fifth embodiment. Hereinafter, Operations using the computation memory are mainly described. FIG. 15 is a block diagram of the CPU 1 according to the fifth embodiment. A description of parts that have the same functions as those described in the second embodiment is omitted. A dashed line illustrated in FIG. 15 represents a line for supplying power to the stacked memories 2.

A power supply circuit 4 starts supplying power to the stacked memories 2. After that, when receiving, from a memory power supply manager 106, an instruction to turn off a power supply for a computation memory included in the stacked memories 2, the power supply circuit 4 stops supplying power to the stacked memories 2. Then, when receiving, from the memory power supply manager 106, an instruction to turn on the power supply for the computation memory included in the stacked memories 2, the power supply circuit 4 starts supplying power to the stacked memories 2.

When the activation of the OS is completed, the memory power supply manager 106 receives, from the OS executing section 101, a notification indicating the turning off of the power supply for the computation memory that is a memory other than the OS memory. Then, the memory power supply manager 106 instructs the power supply circuit 4 to turn off the power supply for the computation memory, and the power supply circuit 4 turns off the power supply for the computation memory that is the memory other than the OS memory. For example, if the memory 204 that is the outermost layer memory of the stacked memories 2D illustrated in FIG. 5 is used as the OS memory, the memory power supply manager 106 turns off a power supply for a memory other than the memory 204.

When the operator enters a request to assign a job, the memory power supply manager 106 receives, from the OS executing section 101, a notification indicating the turning on of the power supply for the computation memory. Then, the memory power supply manager 106 instructs the power supply circuit 4 to turn on the power supply for the computation memory, and the power supply circuit 4 turns on the power supply for the computation memory. After that, when the execution of the job is completed, the memory power supply manager 106 receives, from the OS executing section 101, a notification indicating the turning off of the power supply for the computation memory. Then, the memory power supply instructs the power supply circuit 4 to turn off the power supply for the computation memory, and the power supply circuit 4 turns off the power supply for the computation memory.

When the activation of the OS is completed, the OS executing section 101 transmits, to the memory power supply manager 106, a notification indicating the turning off of the power supply for the computation memory. After that, the OS executing section 101 receives a request to assign a job from the operator and transmits, to the memory power supply manager 106, a notification indicating the turning on of the power supply for the computation memory. When receiving a notification indicating the completion of the execution of the job from the job executing section 102, the OS executing section 101 transmits, to the memory power supply manager 106, a notification indicating the turning off of the power supply for the computation memory.

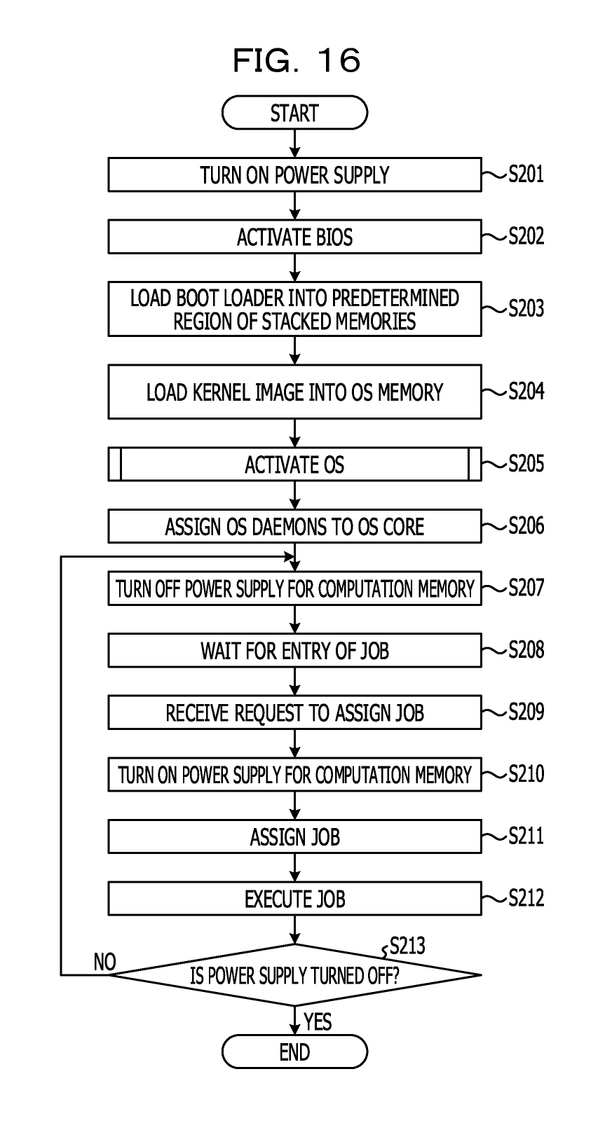

Next, the activation of the OS by the computer 100 according to the fifth embodiment and control of the power supply for the computation memory are described with reference to FIG. 16. FIG. 16 is a flowchart of the activation of the OS by the computer 100 according to the fifth embodiment and the control of the power supply for the computation memory.

First, the CPU 1 detects that the power supply for the computer 100 is turned on by the operator (in step S201). When the power supply is turned on, the power supply circuit 4 supplies power to the CPU 1, the stacked memories 2, and the hard disk drive 3.

Next, the CPU 1 activates the BIOS (in step S202). The CPU 1 causes the BIOS to execute a diagnostic test on the stacked memories 2, the hard disk drive 3, and the like

Then, the CPU 1 causes the BIOS to load the boot loader into a predetermined region of the stacked memories 2 (in step S203).

The CPU 1 causes the boot loader to load the kernel image into the outermost layer memory of the stacked memories 2 (in step S204), while the outermost layer memory of the stacked memories 2 is the OS memory.

The CPU 1 causes the kernel to activate the various daemons using the outermost layer memory of the stacked memories 2 and thereby activates the OS (in step S205).

After that, the CPU 1 causes the OS to assign the daemons to the OS core 11 using the taskset command (in step S206).

Then, the CPU 1 instructs the power supply circuit 4 to turn off the power supply for the computation memory included in the stacked memories 2. The power supply circuit 4 receives the instruction from the CPU 1 and turns off the power supply for the computation memory (in step S207). After that, the CPU 1 waits for an entry of a job (in step S208). Then, the CPU 1 receives a request to assign the job from the operator (in step S209).

The CPU 1 instructs the power supply circuit 4 to turn on the power supply for the computation memory included in the stacked memories 2. The power supply circuit 4 receives the instruction from the CPU 1 and turns on the power supply for the computation memory (in step S210). After that, the CPU 1 assigns the job to the computing core 12 (in step S211). Then, the computing core 12 of the CPU 1 executes the assigned job (in step S212).

After that, the CPU 1 determines whether or not the power supply for the computer 100 has been turned off by the operator (in step S213). If the power supply is not turned off (No in step S213), the CPU 1 causes the process to return to step S207 and waits for an entry of a job.

If the power supply has been turned off (Yes in step S213), the CPU 1 shuts down the OS and stops the computer 100.

As described above, the information processing device according to the fifth embodiment turns off the power supply for the computation memory (to be used to process a job) during the time when a job is not executed. If the power supply for the computation memory is turned on, the memory is refreshed in order to maintain stored information. Thus, when the power supply is turned on and data is not read and written, the memory generates heat. Since the power supply for the computation memory is turned off during the time when a job is not executed, it may be possible to suppress generation of heat from the memory. Thus, the information processing device according to the fifth embodiment may suppress generation of heat from the memory and maintain the temperature of the memory at a low level.

In addition, power consumption may be suppressed by turning off a power supply for a computation memory that is not used.

### Sixth Embodiment

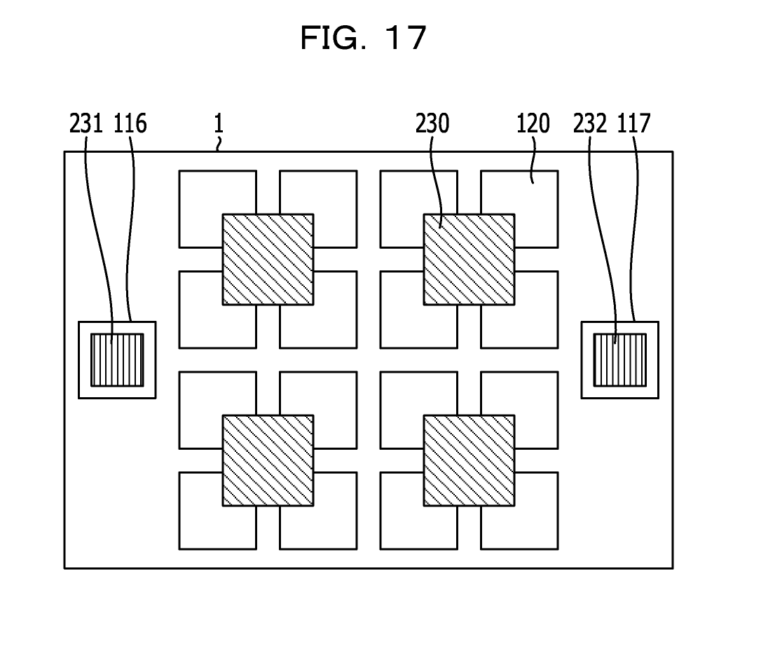

FIG. 17 is a plan view of the CPU 1 according to a sixth embodiment. The CPU 1 of the computer 100 according to the sixth embodiment has two OS cores 116 and 117, for example. The CPU 1 also has sixteen computing cores 120, for example. The CPU 1 has stacked memories 231 on the OS core 116 and stacked memories 232 on the OS core 117. The CPU 1 has four groups of stacked memories 230 on the computing cores 120, for example.

The stacked memories 231 are assigned as memories to be used by the OS core 116. The stacked memories 232 are assigned as memories to be used by the OS core 117.

The OS core 116 uses the stacked memories 231 to activate the OS and execute the processes of the OS. The OS core 117 uses the stacked memories 232 to activate the OS and execute the processes of the OS.

In recent years, a memory region that is used to execute the OS tends to be small. Thus, the stacked memories 231 and 232 that are used to execute the OS may have a smaller capacity than conventional memories. For example, the stacked memories 231 and 232 may each have a capacity of approximately 1 GB, for example.

Thus, the numbers of layers of the stacked memories 231 and 232 may be reduced. For example, the number of layers of the stacked memories 231 and the number of layers of the stacked memories 232 may by one or two. Thus, the memory layers that are included in the stacked memories 231 and 232 each have a high cooling efficiency. Since the OS cores 116 and 117 use the stacked memories 231 and 232 to execute the OS, the stacked memories 231 and 232 that each have a high cooling efficiency may be used as the OS memories that continuously generate heat. Thus, the generation of heat due to the execution of the OS may be suppressed.

The computing cores 120 execute jobs entered by loading of the jobs into the stacked memories 230.

The stacked memories 230 that are memories for jobs each have a larger capacity than the stacked memories 231 and 232 that are memories for the OS. Since the stacked memories 230 are used for the execution of jobs, the stacked memories 230 are not used during the time when a job is not executed. Thus, the stacked memories 230 do not continuously generate heat. Even if the stacked memories 230 are composed of many memory layers and include a memory layer with a low cooling efficiency, the temperatures of the stacked memories 230 are not likely to be high. Even when the stacked memories 230 are used for the execution of a job, the temperatures of the stacked memories 230 are not so high.

As described above, the information processing device according to the sixth embodiment uses, as OS memories, the memories 231 and 232 that are mounted in OS core regions and are composed of small numbers of layers. Thus, the CPU 1 may execute the OS using the memories that have a high cooling efficiency. The memories 231 and 232 that are used for the execution of the OS have the high cooling efficiency among the stacked memories 230 to 232. The stacked memories 231 and 232 that are continuously used as the OS memories and continuously generate heat have the high cooling efficiency, while the other stacked memories 230 are used when an application is executed. It may be therefore possible to improve the cooling efficiencies of the overall memories, maintain the temperatures of the memories at low levels, and improve the service life of the memories.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a processor; and
a plurality of memories arranged on the processor and coupled to the processor,
wherein the plurality of memories are stacked on each other, and
wherein a first memory that is located farthest from the processor among the plurality of memories is allocated for a program for managing the information processing device, and the processor executes the program.

2. The information processing device according to claim 1,
wherein after the processor activates the program, the program is continuously executed.

3. The information processing device according to claim 1,
wherein the program is basic input output system.

4. The information processing device according to claim 1,
wherein the program is an operating system.

5. The information processing device according to claim 1,
wherein the processor is configured to cause the program to be stored into the first memory when the information processing device is activated.

6. The information processing device according to claim 1,
wherein the processor is configured to execute an application program using a second memory that is among the plurality of memories and different from the first memory.

7. The information processing device according to claim 6,
wherein the application program is stored into the second memory.

8. The information processing device according to claim 1, further comprising:
a plurality of storage devices that each have the plurality of memories,
wherein the first memory is located farthest from the processor among the plurality of memories included in a first storage device that is located closest to the processor among the plurality of storage devices.

9. The information processing device according to claim 1,
wherein the processor is configured to control supply of power to memories that are among the plurality of memories and different from the first memory.

10. A method for controlling an information processing device that has a processor and a plurality of memories arranged on the processor, coupled to the processor, and stacked on each other, comprising:
allocating a first memory located farthest from the processor among the plurality of memories for a program for managing the information processing device; and
causing the processor to execute the program.

11. The method according to claim 10,
wherein after the processor activates the program, the program is continuously executed.

12. The method according to claim 10,
wherein the program is basic input output system.

13. The method according to claim 10,
wherein the program is an operating system.

14. The method according to claim 10, further comprising:
storing the program into the first memory when the information processing device is activated.

15. The method according to claim 10, further comprising:
allocating a second memory that is among the plurality of memories and different from the first memory for an application program.

16. The method according to claim 15, further comprising:
storing the application program into the second memory.

17. The method according to claim 10, wherein
the information processing device further includes a plurality of storage devices that each have the plurality of memories, and
the first memory is located farthest from the processor among the plurality of memories included in a first storage device that is located closest to the processor among the plurality of storage devices.

18. The method according to claim 10, further comprising:
controlling supply of power to memories that are among the plurality of memories and different from the first memory.

19. A computer-readable recording medium storing a program for causing a computer including a plurality of memories stacked on each other and a processor coupled to the plurality of memories to execute a process, the process comprising:
allocating a first memory located farthest from the processor among the plurality of memories for a program for managing the computer in; and
causing the processor to execute the program for managing the computer.

20. The computer-readable recording medium according to claim 19, the process further comprising:
storing the program into the first memory when the information processing device is activated.
